(19) United States
(12) Patent Application Publication
(10) Pub. No.: US 2006/0181837 A1
(43) Pub. Date: Aug. 17, 2006

(54) Combined transformer and prefabricated substations

(76) Inventors: Bing Sun, Shanghai (CN); Shaojun Zheng, Shanghai (CN); Aihe Liu, Shanghai (CN)

Correspondence Address: BUTZEL LONG, 350 SOUTH MAIN STREET, SUITE 300, ANN ARBOR, MI, 48104, US

(21) Appl. No.: 10/549,982

(22) PCT Filed: Jan. 20, 2004
(86) PCT No.: PCT/CN04/00076

§ 371 Date: Sep. 19, 2005

(30) Foreign Application Priority Data
Mar. 19, 2003 (CN) 03108110.X
Jun. 6, 2003 (CN) 03231909.6

(51) Int. Cl. H02B 5/00

(52) U.S. Cl. 361/602

(57) ABSTRACT

A combined transformer is comprised of a transformer chamber, a low-voltage chamber, a high-voltage chamber and a radiator. There is a hollow thermal pipe filled with a heat-transfer medium in the radiator. One of the ends of the thermal pipe is plugged into the transformer chamber and on being located the other end there are heat sinks. Wherein the low-voltage chamber being located on the transformer and the high-voltage chamber being on the side of the transformer, the transformer chamber and the high-voltage chamber are embedded in the ground. The prefabricated substations are comprised of a transformer chamber, a transformer arranged in the transformer chamber, a switch chamber including a low-voltage chamber and a high-voltage chamber, a radiator and a hollow thermal pipe filled with a heat-transfer medium in the radiator. One of the ends of the thermal pipe is plugged into the transformer chamber and the other end is arranged thermally-conductive sheets, the thermally conductive sheets are located on the outside of the switch chamber which is arranged on the transformer chamber. The high-voltage chamber and the low-voltage chamber both have doors the transformer chamber is enclosed with a pit and a cover. The said thermal pipe of the transformer dose not only has the large capacity, the long using life and high reliability, small size and the heat-transfer effect greatly improved but greatly reduces the occupation area of the transformer.

### TECHNICAL FIELD

This invention relates to cubicle type substations and especially to combined transformer and prefabricated substations.

### BACKGROUND OF THE INVENTION

Cubicle type substations are widely used in the power transmission and distribution industry and include combined transformer and prefabricated substations. The introduction is as follows:

Combined Transformer

Combined transformer is a term used in China Machinery Industry Standard JB/T 10217-2000 “Combined Transformer.” Since the technology of this product comes from U.S.A., the combined transformer is also called “American Cubicle Transformer.”

In American National Standard ANSI/IEEE C57.12.26, combined transformers are called “three Phases Compartment-Type Pad-Mounted Transformers.” In the above standard, in Chinese patents such as “New type of combined transformer” (Patent No. 00217238.0), and in the product catalogs of American GE company and Shanghai Zhixin Company, the typical structure of a combined transformer is shown as FIG. 1, which mainly includes a transformer chamber, HV load switch, protection fuse, radiator, HV chamber and LV chamber etc, wherein:
1. The transformer chamber, HV chamber, LV chamber and radiator are provided in a compact planar arrangement on a platform pedestal;
2. The transformer, HV load switch, protective fuse, HV & LV connection wire and transformer oil are provided in the transformer chamber;
3. The incoming LV cable at the bottom of LV chamber is connected to the transformer output end in the transformer chamber;
4. The incoming HV cable at the bottom of HV chamber is connected to the transformer input end in the transformer chamber;
5. The radiator is located at a side wall of the transformer chamber; and
6. Instruments, cable plug, fuse stand and auxiliary equipment are located in the HV chamber or the LV chamber;

FIG. 2 is “Triangle shape” plan layout and main circuit diagram showing the relation between the transformer chamber, the HV chamber and the LV chamber. FIG. 3 shows a “Parallel” plan layout or other plan layout.

As the requirement for urban environment beautification progresses people hope to reduce the area occupied by combined transformers. In this regard, the American cubicle type transformer has following disadvantages in structural features:
1. Large areas are occupied for the combined planar arranged transformer shown in FIGS. 1, 2 and 3. When this transformer is installed on the ground, the total occupied area is the sum of the transformer chamber, the HV chamber, the LV chamber and the radiator which are arranged in a planar manner;
2. If the combined transformer is completely buried underground, the equipment operation and maintenance will be inconvenient. Also, it is not good for auxiliary equipment such as instruments which require waterproofing to be buried. Furthermore, burying will cause problems for the large amount of radiation produced by the transformer.

Prefabricated Substation

In order to meet the requirement which is to arrange power supply cables underground in downtown districts and busy streets in power transmission applications, the prefabricated substation which can transfer HV (1-53 KV) into LV (0.4 KV) is widely used.

Chinese National Standard GB/T17467-1998 “HV/LV Prefabricated Substation” and the International Electrician Committee IEC1330:1995 “HV/LV Prefabricated Substation” stipulate: The prefabricated substation which mainly consists of transformer, HV switch equipment and control equipment, LV switch equipment and control equipment, related internal connection wire (cable, bus bar and others) shall be enclosed with a common casing or a group of casings. The common casing or a group of casings of prefabricated substations is normally divided into three compartments: the HV chamber, the LV chamber and the transformer chamber. In Mr. Hu Zhaoming and Shen Wei's “Cubicle Type Substation” electric power equipment 2000 (1) and William Stemmons “Packaged Power Control Assemblies” Copyright Material IEEE Paper No. PCIC 84-11 technical document and Chinese patent “Prefabricated Substation in Basement” (Patent No. 00205369.1), all the three compartments of prefabricated substations having existing open technology are provided in a planar, parallel and compact layout. Referring to FIGS. 12, 13 and 14, a “Parallel” layout and two “Triangle” layouts can be seen, which are placed on the ground or all or part of the substations are installed underground. The prefabricated substation is different from the conventional civil constructed substations, which include a transformer, HV and LV switch, control equipment, auxiliary equipment as well as a casing are all assembled into a complete prefabricated assembly in a factory. Then, the whole or part of the prefabricated assembly is carried to a site, (see FIG. 10). After site installation and connection of external incoming & outgoing cables, the installed, prefabricated assembly can be put into use.

With the requirement of urban environment beautification, the shortage of existing prefabricated substations has been clearly shown. Large areas have been occupied by substations—since the three compartments are arranged in parallel in a planar manner, the occupied area is the sum total of the three compartments which occupies a large space—this is because the space needed for the whole installation is great. If part of the installation is underground, the waterproof requirement for the HV chamber and the LV chamber will be extremely high and the equipment operation and maintenance will be inconvenient. Meanwhile, the radiation generated from the transformer chamber will produce a high heat output which will be difficult to dissipate with natural ventilation. In addition, the construction cost for an underground pit is high, and if the whole substation is buried underground, an artificial radiation ventilation facility needs to be provided.

### SUMMARY OF THE INVENTION

An object of the present invention is to provide a cubicle type substation with good radiating effect.

Another object of the present invention is to provide a combined transformer and a prefabricated substation that occupies a small area and is convenient to operation.

The combined transformer includes a transformer chamber, LV chamber, HV chamber and radiator that includes a hollow heat pipe in which a heat transferring medium is filled. One end of the heat pipe is inserted into the transformer chamber, the other end thereof is provided with radiating fins. The LV chamber is set above the transformer chamber while the HV chamber is set at the side of transformer chamber. The transformer chamber and HV chamber are buried underground. The radiating fins are set above the transformer chamber. The traditional liquid radiating fin is located at the side of the transformer chamber.

The prefabricated substation includes a transformer chamber, a transformer installed in the transformer chamber, switch room with LV and HV chamber, and a that has a hollow heat pipe in which a heat transferring medium is filled. One end of the heat pipe is inserted into the transformer, while the other end is provided with radiating fins. The radiating fins are at the outside of the switch room. The switch room is set above the transformer chamber. The HV chamber and the LV chamber each has a door. The transformer chamber is enclosed within ground pit and covered with a cover plate.

In above combined transformer and prefabricated substation, the heat transferring capacity of the heat pipe is great, and the substation has a long service life, a high reliability and occupies a small volume. The radiating effect has been greatly improved. Furthermore, the layout has been changed from the traditional layout so that the transformer chamber, LV chamber and HV chamber are arranged in a parallel and compact way in the same plane. The transformer chamber with large volume, the HV chamber with less operation and radiator at the bottom are set at the lower layer. The LV chamber with frequent operation, maintenance and high waterproof requirement as well as top radiator is set at the upper layer. In application, the lower layer is set underground, and with the upper layer above the ground, the occupied area has been reduced 60-70% compared with the traditionally planar arranged combined transformer. The prefabricated substation having a switch room set above the transformer room can reduce the occupied area 30-40%. In addition, since the switch room for the prefabricated substation is set above the transformer room and above ground, the waterproof and damp-proof function can be realized, meanwhile, the doors for the HV chamber and the LV chamber are easy to be opened, thus, it is convenient for equipment operation and maintenance in the HV chamber and the LV chamber. The transformer room is set underground and natural ventilation and radiation for the transformer can be realized via heat pipe radiator. The oil-immersed transformer has high running reliability and good waterproof performance, hence, 20 years' free of maintenance can be realized.

### BRIEF DESCRIPTION OF THE DRAWINGS

FIG. 1 is a typical structural view of an existing combined transformer.

FIG. 2 is a “Triangle” plan layout and main circuit diagram of the combined transformer in FIG. 1.

FIG. 3 is a “Parallel” plan layout and main circuit diagram of the combined transformer in FIG. 1.

FIG. 4 is a solid structural layout of a combined transformer of the present invention.

FIG. 5 is another solid structural layout of a combined transformer of the present invention.

FIG. 6 is a structural view of the top heat pipe radiator.

FIG. 7 is a structural view of the socket, operating handle, regulating handle in the LV chamber of combined transformer.

FIG. 8 is a structural view of the socket, operating handle, regulating handle in the HV chamber of combined transformer.

FIG. 9 is a schematic structural view of the combined transformer of the present invention installed in the ground pit.

FIG. 10 is a structural view of the existing prefabricated substation by overall transportation and hoisting.

FIG. 11 is a structural layout and main circuit diagram for the HV chamber, the LV chamber and transformer chamber in existing prefabricated substation.

FIGS. 12, 13, 14 are the three kinds of plan layout for the HV chamber, the LV chamber and transformer chamber in existing prefabricated substation, respectively.

FIG. 15 is a structural layout and main circuit diagram for the prefabricated substation of the present invention.

FIG. 16 is a plan layout of the prefabricated substation of the present invention.

FIG. 17 is a solid structural layout for the prefabricated substation of the present invention.

FIG. 18 is a structural view for heat pipe radiator.

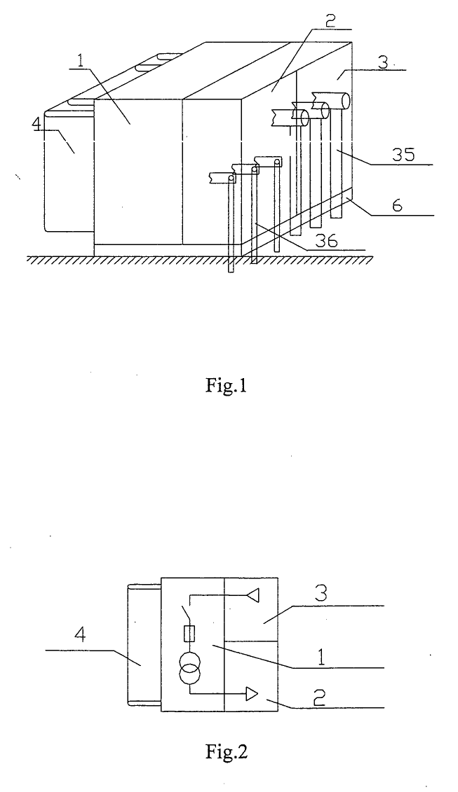

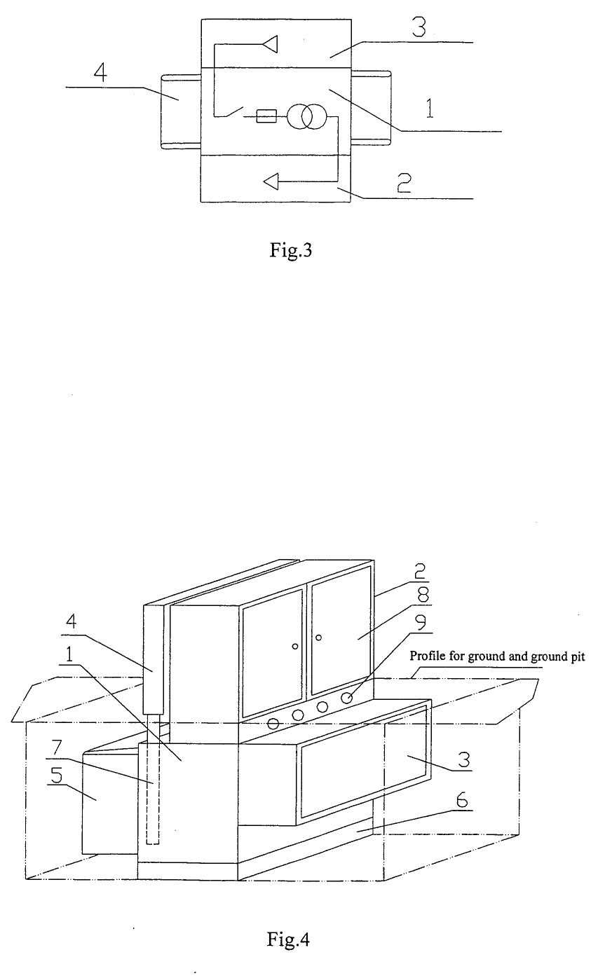

### DETAILED DESCRIPTION OF THE PREFERRED EMBODIMENTS

The following is the further description with two practical examples for the cubical type substation of the present invention. See reference drawings.

Combined Transformer

Referring to FIGS. 4-8, the combined transformer of the present invention includes transformer chamber 1, LV chamber 2, HV chamber 3, top radiator 4, bottom radiator 5, platform stand 6, transformer 13, transformer oil 14, protective fuse 15, HV load switch 16, tap switch 17, socket 24 for protective fuse 15, operating handle 25 for HV load switch 16, regulating handle 26 for tap switch 17, LV outgoing terminal 20, and HV cable socket 27.

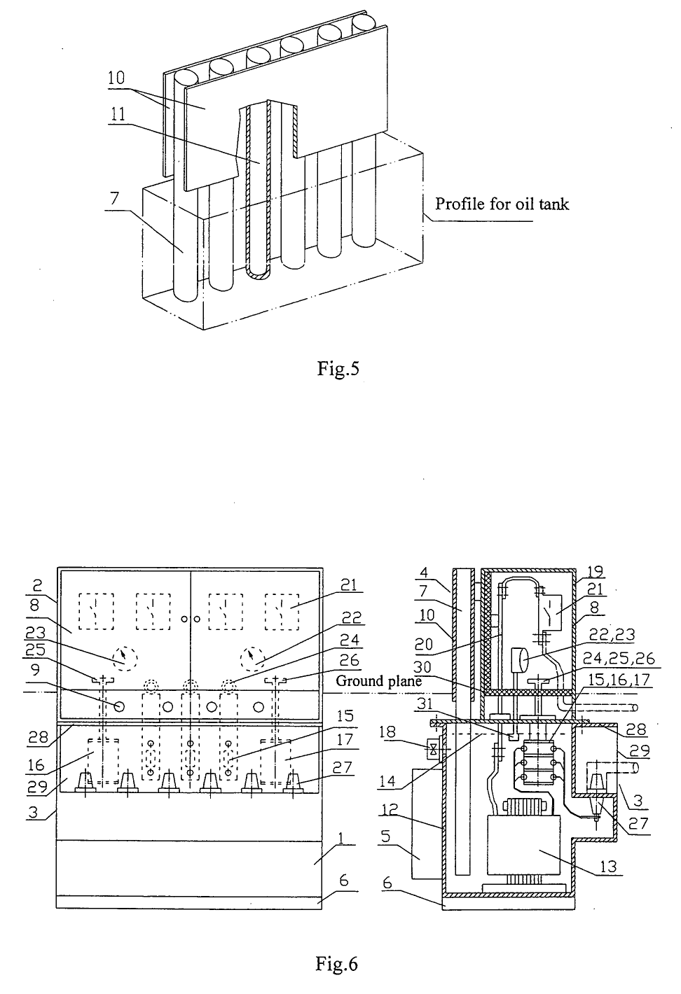

The top radiator 4 is set above the transformer chamber 1 (FIG. 4). In addition, a split-type structure can also be adopted for the top radiator 4 and transformer chamber 1 (FIG. 5). The top radiator 4 includes heat pipes 7 and radiating fins 10. Many arrangement styles are available for the top radiator 4. The Heat pipes 7 and radiating fins 10 can be set at one side or three sides of the LV chamber 2, or can also be set on the top of the LV chamber 2. The top radiator 4 is implemented by the heat pipes 7 connecting to the transformer chamber 1, and the radiating fins 10 are provided on the heat pipes 7 to improve the radiating effect of the heat pipes 7.

The heat pipes 7 consist of steel or copper pipes, the radiating fins 10 are made of steel plates or aluminum plates, and the heat pipes 7 are the radiating fins 10 are welded together. The lower section of the heat pipes 7 can be inserted into the transformer chamber 1 to contact the transformer oil 14 and improve the heat absorption effect for heat pipes 7. The heat pipes 7 can also be welded to a side of transformer chamber 1 so as to reduce the influence to the equipment in transformer chamber 1. The heat pipes 7 transfer the heat in transformer chamber 1 to radiating fins 10 via the medium in heat pipe cavity 11. The radiating fin radiates the heat into the atmosphere above the ground to solve the heat problem since the transformer chamber 1 is buried underground. The bottom radiator 5 is a conventional transformer oil radiator.

The transformer oil 14 is filled up in transformer chamber 1. Not only is the transformer 13 immersed in the oil but also the protective fuse 15, HV load switch 16, and tap switch 17 are immersed in the oil. The transformer oil is fully used to realize insulation.

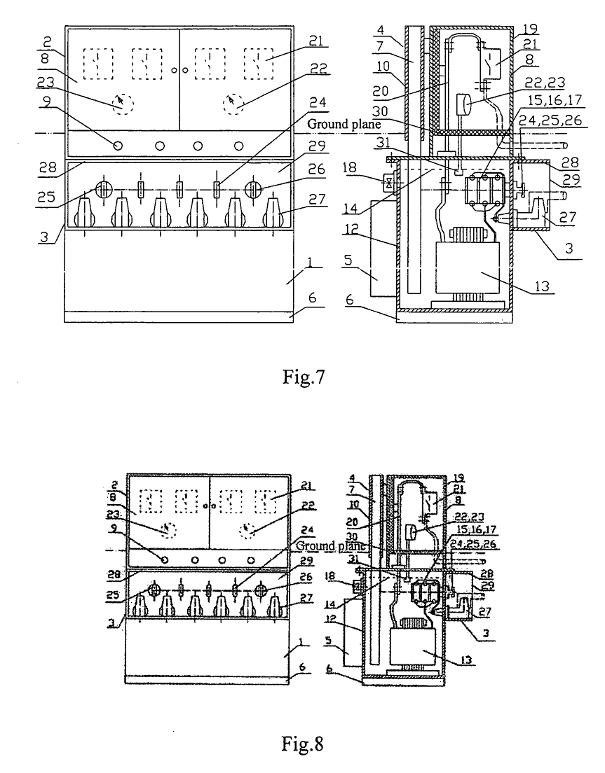

The socket 24 for protective fuse 15, operating handle 25 for HV load switch 16, and regulating handle 26 for tap switch 17 are set in the LV chamber 2 (FIG. 7), thereby the operating the combined transformer from in the LV chamber 2 is convenient.

In order to reduce the volume of the upper layer, the socket 24 for protective fuse 15, operating handle 25 for HV load switch 16, and regulating handle 26 for tap switch 17 can also be set in the HV chamber 3 (FIG. 8). During the operation, the operator needs to go down into the pit and work around the pit.

The LV outgoing terminal 20 is located in the LV chamber 2. The HV cable socket 27 is located in the HV chamber 3.

An insulation layer 30 is provided between the LV chamber 2 and transformer chamber 1 or radiating fins 10 to prevent the heat in transformer chamber 1 or radiating fins 10 from entering the LV chamber 2.

The bottom radiator 5 is set at the side of the transformer chamber 1 to improve the radiating effect of transformer chamber 1. The heat generated thereof can be transferred into the pit and eliminated out along the periphery of the pit.

A door 8 is provided at a side of the LV chamber 2 so as to open it easily and enter the LV chamber 2 for operation. Under the door 8 is underground cable entry 9, which is used for the LV cable incoming.

In the LV chamber 2 are LV switch 21, oil temperature gauge 22 and oil level meter 23, which are used to control the running status.

As shown in FIG. 6, the transformer chamber 1 includes sealed box 12 welded with a steel plate. The box 12 contains transformer 13, transformer oil 14, protective fuse 15, HV load switch 16 and tap switch 17. Outside the box 12 is pressure relief valve 18. The selection and installation for these parts are the same as the conventional ones; wherein the socket 24 for protective fuse 15, operating handle 25 for HV load switch 16, and regulating handle 26 for tap switch 17 are arranged in the LV chamber 2 at an upper layer for easy operation.

As shown in FIG. 7 which is a front view and section view, the LV chamber 2 is made into box 19 with steel plate. Box 19 is provided with a door 8 and underground cable entry 9. The LV outgoing line from transformer 13 is introduced to LV outgoing terminal 20 via conductor. A power supply for LV outgoing terminal 20 will go out from underground cable entry 9 through cable after passing LV switch 21. An oil temperature gauge 22 and oil level meter 23 are installed in the box 19 for easy observation. An oil temperature and level probe 31 are in the transformer oil 14. The HV chamber 3 has waterproof HV cable socket 27. A steel partition 28 for safety protection is provided above the cable socket 27, and a HV cable entry 29 is located outside of the cable socket 27.

As can be seen from FIG. 8 which is a front view and section view, another type of HV chamber 3 includes the socket 24 for protective fuse 15, operating handle 25 for HV load switch 16, and regulating handle 26 for tap switch 17. An HV cable socket 27 adopts upper/lower plug-in/out structure installed in vertical plane. The structure simplifies the fabrication of box 12 and is convenient for HV cable installation. The difference between the embodiment of the invention shown in FIGS. 7 and 8 is that the socket 24 for protective fuse 15, operating handle 25 for HV load switch 16 and regulating handle 26 for tap switch 17 are installed in the HV chamber 3 in FIG. 8

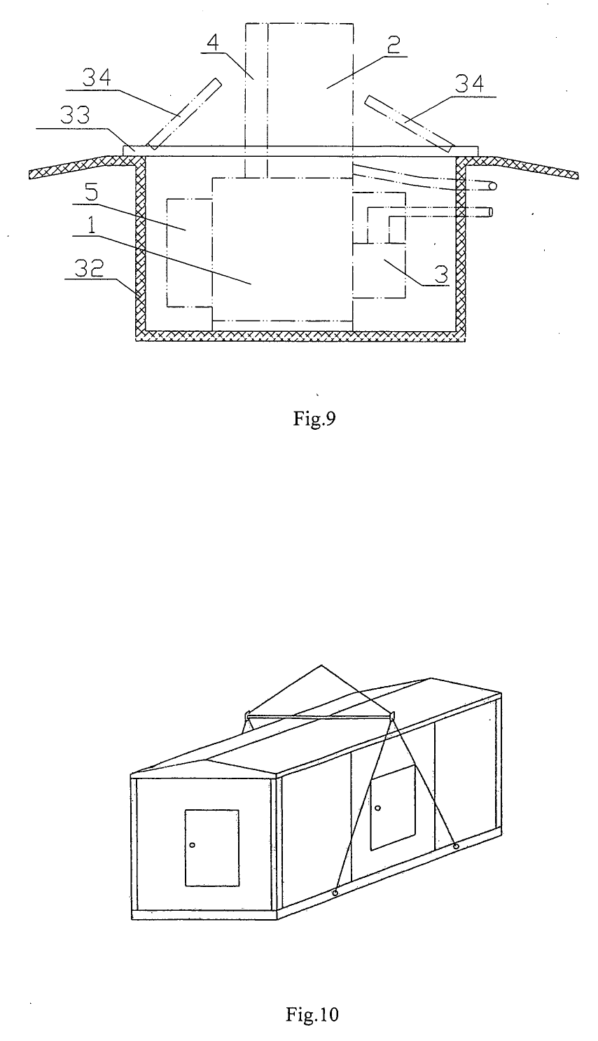

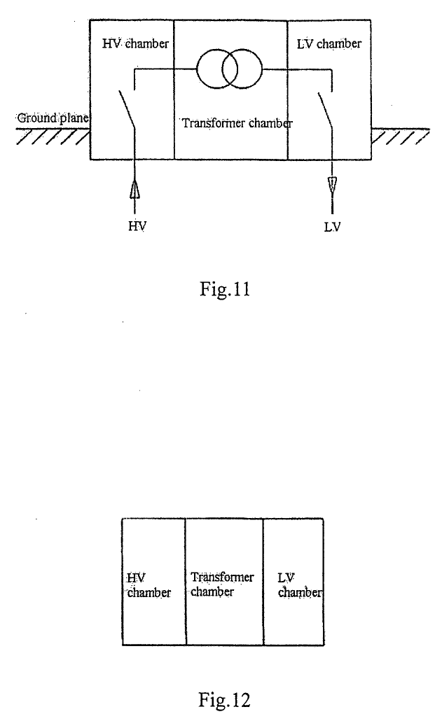

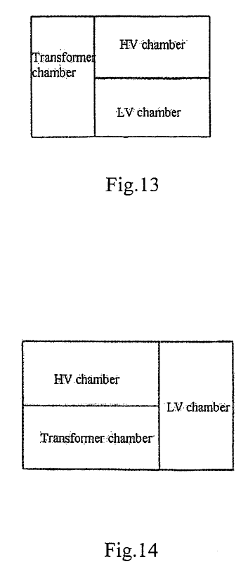

Referring to FIG. 9, for installation, a ground pit 32 can be built under the ground, and the lower parts, such as transformer chamber 1, HV chamber 3, etc. are put into the ground pit 32, and the upper parts such as LV chamber 2, etc. are exposed above the ground. The ground pit is provided with a cover 33 at the opening thereof. By opening the ground pit cover plate 34, connection of the cables and operation and maintenance can be performed.

Based on the design principle, the transformer chamber, bottom radiator and HV chamber at lower layer are made of anti-corrosive steel plate with surface anti-corrosive treatment. An air grid inlet is provided on the cover plate of the bottom radiator. The oil-immersed transformer with high reliability can realize waterproof function and 20 years' of free of maintenance. Incoming HV cable adopts all-sealed plug-in/out connector and can be safely operated on hot line under the water. The HV chamber does not need watertight function so that the cost is reduced.

In accordance with the design principles of the present invention, only one of the top radiator and the bottom radiator can be used based on different radiation requirement. If the underground transformer fails, similar to conventional combined transformer, the replacement method for the whole body can be adopted so that a rapid and convenient maintenance can be realized to ensure the power supply.

This invention adopts an upper/lower overlap structure for the transformer chamber, the LV chamber, the HV chamber and the top and bottom radiator, i.e., the half of waterproof transformer chamber, the HV chamber and the bottom radiator which are free of maintenance and operation are buried underground. The LV chamber and the top radiator which have high waterproof requirement and need operation and maintenance are placed above the ground. On the premise of being suitable for running and maintenance, for meeting site installation requirements and not increasing costs, the occupied area by the combined transformer has been reduced in a maximum degree and in a optimum way so as to reach the goal of environment beautification.

Prefabricated Substation

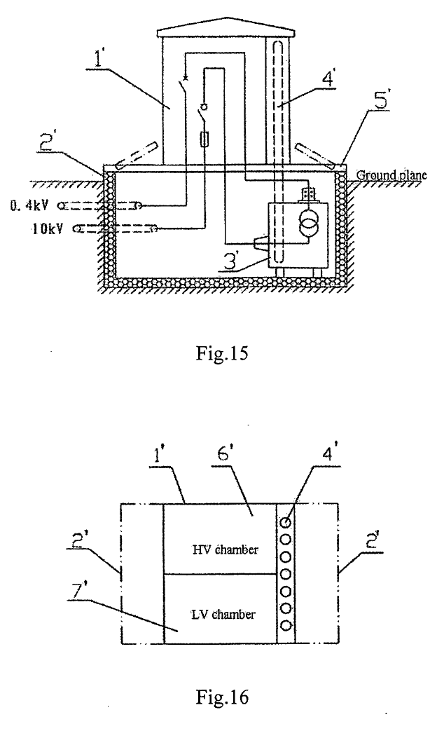

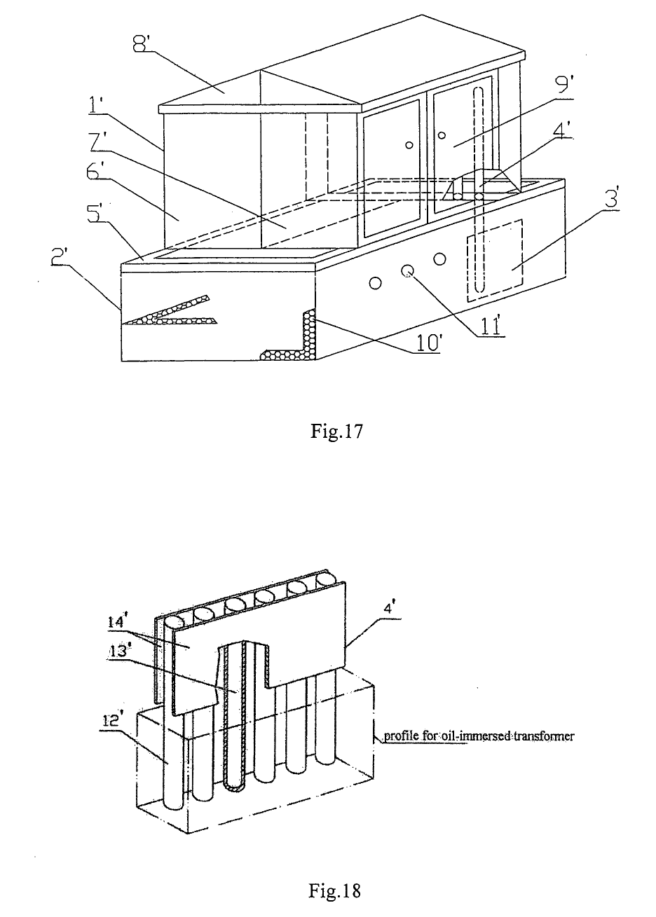

As shown in FIGS. 15-18, the prefabricated substation consists of switch room 1′, transformer chamber 2′ and transformer 3′ installed in transformer chamber 2′. In the switch room 1′ are HV chamber 6′ and LV chamber 7′. The outside of the switch room 1′ is provided with heat pipe radiator 4′. The switch room 1′ is set above the transformer chamber 2′. Heat pipe radiator 4′ is connected on the transformer 3′. In the heat pipe radiator 4′ is a group of steel heat pipes 12′ with heat transferring medium 13′ filled up inside. The lower end of heat pipe 12′ is connected to the inside of transformer 3′, while the upper end thereof is provided with metal radiating fins 14′. Radiating fins 14′ are located at the outer side of switch room 1′. Above the switch room 1′ and heat pipe radiator 4′ is tilting top cover 8′. Door 9′ provides access to HV chamber 6′ and LV chamber 7′. In the transformer chamber 2′ is a concrete ground pit 10′ with steel cover plate 5′ covering the top. A cable entry opening 11′ is provided in the side of ground pit 10′. The transformer 3′ is an oil-immersed transformer. The connection between transformer HV and LV terminals and HV chamber 6′ and LV chamber 7′ uses waterproof cable, and a waterproof socket is used for cable gland. During the installation, the transformer chamber 2′ with oil-immersed transformer 3′ installed is buried underground. The switch room 1′ which is not easy to perform waterproofing and needs maintenance above the transformer chamber and expose it above the ground for easy maintenance and waterproofing is placed above ground. During the operation, a natural ventilation and radiation for oil-immersed transformer 3′ can be realized via heat pipe radiator 4′. Therefore, on the premise of meeting the requirement of normal running and maintenance for the substation, the occupied area has been reduced so that the goal to beautify the environment is achieved.

During the installation and application, it is only necessary to build a ground pit under the ground and place the lower parts including such as transformer chamber with installed transformer into the pit and allow the upper parts including such as LV chamber to remain above the ground. A cover plate is provided at the ground pit opening. The ground pit cover plate is opened to carry out transformer installation, cable connection and maintenance to some of the equipment. If the transformer in lower parts underground fails, similar to existing substation, maintenance can be quick and convenient and power supply can be ensured.

1. A combined transformer which comprises:
a transformer chamber containing transformer oil;
a LV chamber;
a HV chamber; and
a radiator that has a hollow heat pipe in which a heat transferring medium is filled with one end of the heat pipe being inserted into the transformer oil in the transformer chamber and another end of the heat pipe being provided with radiating; fins,
the combined transformer further comprises a double-layer structure having upper and lower layer components.

2. The combined transformer of claim 1, wherein the lower layer component of the double-layer structure is buried underground.

3. The combined transformer of claim 1, wherein the LV chamber is located in the upper layer, and the transformer chamber and the HV chamber are located in the lower layer, and the HV chamber is positioned beside the transformer chamber.

4. The combined transformer of claim 3, wherein the transformer chamber and HV chamber are buried underground.

5. The combined transformer of claim 4, wherein the radiating fins are set provided above the transformer chamber.

6. The combined transformer of claim 4, wherein liquid radiating fins are provided on a side of the transformer chamber.

7. The combined transformer of claim 4, wherein the transformer chamber comprises a sealed box in which a transformer, transformer oil, protective fuse, HV load switch and a tap switch are contained and a pressure relief valve for the box is provided on a side wall of the box.

8. The combined transformer of claim 4, wherein the LV chamber comprises a door and an underground cable entry, and the LV chamber contains a LV outgoing terminal, a LV switch, an oil temperature meter and an oil level meter.

9. The combined transformer of claim 4, further comprising a HV cable socket and a HV cable entry are that are provided in the HV chamber.

10. The combined transformer of claim 8, further comprising a socket for protective fuse, an operation handle for HV load switch and a regulating handle for a tap switch.

11. The combined transformer of claim 4, wherein an insulation layer is provided in the LV chamber at the bottom thereof and close to the transformer chamber.

12. A prefabricated substation comprising:
a transformer chamber containing transformer oil;
a transformer provide in the transformer chamber;
a switch room;
LV and HV chambers provided in the switch room; and
a radiator having a hollow heat pipe in which heat transferring medium is filled with one end of the heat pipe being inserted into the transformer oil in the transformer chamber and another end of the heat pipe being provided with radiating fins, the radiating fins being provided on an outer side of the switch room,
the prefabricated substation further comprises a double-layer structure having upper and lower layer components.

13. The prefabricated substation of claim 12, wherein the lower layer component of the double layer structure is buried underground.

14. The prefabricated substation of claim 12, wherein the switch room is provided above the transformer chamber.

15. The prefabricated substation of claim 14, wherein the transformer chamber is buried underground.

16. The prefabricated substation of claim 14, wherein the transformer chamber is enclosed within a ground pit and cover plate.

17. The prefabricated substation of claim 16, wherein a cable entry opening is provided at a side of the ground pit.

18. The prefabricated substation of claim 17, wherein the ground pit includes a concrete structure and the cover plate is made of steel plate.

19. The prefabricated substation of claim 14, wherein the transformer comprises an oil-immersed transformer and the prefabricated substation further comprises a waterproof cable that is connected between transformer HV & LV terminals and HV & LV chambers, and a waterproof socket that is used for a cable gland.
